(19) United States
(12) Patent Application Publication
(10) Pub. No.: US 2015/0361930 A1
(43) Pub. Date: Dec. 17, 2015

(54) IMPROVED DIESEL ENGINE EFFICIENCY BY TIMING OF IGNITION AND COMBUSTION USING ULTRAVIOLET LIGHT

(71) Applicants: Richard ECKHARDT, Arlington, MA (US); COMBUSTION 8 TECHNOLOGIES LLC, Butler, WI (US)

(72) Inventors: Richard Eckhardt, Arlington, MA (US); Larry Daniel Nichols, Arlington, MA (US); David B. Cope, Medfield, MA (US)

(21) Appl. No.: 14/762,859

(22) PCT Filed: Jan. 23, 2014
(86) PCT No.: PCT/US14/12696

§ 371 Date: Jul. 23, 2015

Related U.S. Application Data
(60) Provisional application No. 61/755,735, filed on Jan. 23, 2013.
(60) Provisional application No. 61/790,428, filed on Mar. 15, 2013.

(51) Int. Cl. F02M 27/06; F02P 5/04; F02P 23/04

(52) U.S. Cl. CPC F02M 27/06; F02P 23/04; F02P 5/045

(57) ABSTRACT

An exemplary embodiment of a UV light injector assembly is used to apply intense light that includes short wavelength UV to the interior of an engine cylinder near the desired time of fuel ignition. In an example embodiment, the light is produced by a short-arc xenon flash lamp. This flash lamp includes an integral reflector (e.g., a parabolic reflector) to collimate the majority of its light into parallel rays. The assembly includes a window for passing UV light into the cylinder. To direct the collimated rays of light from the flash lamp through the window a UV-transparent condensing lens is used to focus the light from the flash lamp onto the window.

### CROSS-REFERENCE TO RELATED APPLICATIONS

This application claims benefit of Provisional Application No. 61/755,735 filed on Jan. 23, 2013, and of Provisional Application No. 61/790,428, filed on Mar. 15, 2013, the entire contents both of which are incorporated herein by reference.

### FIELD OF THE INVENTION

This invention relates to methods and apparatus for increasing diesel engine efficiency, and more particularly to improving diesel engine efficiency by timing of ignition and combustion using ultraviolet light.

### BACKGROUND

Diesel engines power many automobiles and most commercial trucks in the United States, as well as most stationary generators. Their efficient operation is a matter of great importance economically, environmentally, and in terms of petroleum conservation.

A diesel engine is a type of compression ignition internal combustion engine (ICE) in which a liquid hydrocarbon fuel is sprayed directly into hot compressed air near the top of the compression stroke. Upon spraying, the fuel begins to vaporize and, in due course, to undergo spontaneous ignition and combustion. Gas heated to high temperatures and high pressures by the combustion of the fuel exerts a force on the piston, thereby converting the heat of combustion into useful mechanical work which can be delivered through the crankshaft to an external load.

FIGS. 1A-D illustrate the sequence of strokes of a piston 120 in a cylinder 110—intake (FIG. 1A), compression (FIG. 1B), power (FIG. 1C), and exhaust (FIG. 1D)—by which a four-cycle diesel ICE operates. During the intake stroke, shown in FIG. 1A, air (indicated by arrow 122) is drawn into the chamber 115 of the cylinder 110 as the intake valve 130 opens and the piston 120 descends (indicated by arrow 124). During the following compression stroke, shown in FIG. 1B, both the valve 130 and the exhaust valve 140 are closed and the rising (indicated by arrow 126) piston 120 compresses the air, increasing its pressure and temperature. Liquid hydrocarbon fuel 150 is then injected under high pressure directly into the hot compressed air when piston 120 is near top dead center (TDC). Note that while a 4-cycle engine is described, the principles disclosed herein can be applied to other types of engine (e.g., 2-cycle engines).

The injected fuel immediately begins to vaporize and in due course to burn in the chamber 115. The resulting release of heat energy causes a large additional increase in temperature and pressure, which forces the piston 120 downward (indicated by arrow 128) during the power stroke as illustrated in FIG. 1C. Finally, the exhaust valve 140 opens as shown in FIG. 1D, venting and expelling the chamber 115 contents (indicated by arrow 132) in preparation for the next intake stroke.

Diesel fuels, including petroleum based fuels, biodiesel fuels, and other fuels susceptible to compression ignition, are generally less volatile than the gasoline used in spark ignition engines because they are intended for vaporization at much higher temperatures. Diesel fuel generally contains normal and branched alkanes as well as cycloparaffins and aromatic hydrocarbons. As compared to gasoline, diesel fuel contains a larger fraction of straight chain hydrocarbons which readily auto-ignite when heated. Auto-ignition is necessary in a diesel engine, but can lead to knocking in a spark-ignition engine operating at a high load. Diesel engines are designed to operate with a large excess of air, and for that reason burn more than 99% of the injected fuel, leading to low levels of unburned hydrocarbon emissions.

For combustion temperatures attainable in conventional diesel engines the Second Law of Thermodynamics does not allow more than about 65% of the heat of combustion to be converted into useful work. The actual efficiency is further reduced by in-cylinder heat losses to the cooling system, enthalpy wasted as residual heat, pressure and kinetic energy in the exhaust, and mechanical friction. As a result, most vehicular diesel engines convert only 30% to 40% of the heat of combustion into useful mechanical work.

For the reasons set forth above, methods and systems that allow utilization of a larger fraction of the available energy in diesel fuel would provide an economically valuable increase in power and mileage, as well as associated environmental and fuel conservation benefits.

### SUMMARY

In general, in a first aspect, the invention features a method that includes introducing atomic oxygen and diesel fuel into a combustion chamber in a cylinder of a diesel engine, where the introduction is timed relative to a compression cycle of the cylinder to cause the diesel fuel to ignite with a crankshaft angle near a top of a compression stroke of a piston in the combustion chamber.

Implementations of this aspect may include one or more of the following features:

The ignition of the diesel fuel can occur with the crankshaft angle between about 5° and 10° after top dead center (e.g., about 5°, about 6°, about 7°, about 8°, about 9°, about 10° after top dead center). The atomic oxygen can be introduced by a pulse of ultraviolet light having at least 1 mJ joule of energy (e.g., about 1 mJ, about 5 mJ, about 10 mJ, about 20 mJ, about 50 mJ) at wavelengths below 200 nm. The pulse of ultraviolet light can be produced by a short arc xenon flash lamp and is introduced into the combustion zone through a window or optical coupling. The window or optical coupling can be made of high purity synthetic fused silica, sapphire, or another strong, heat-resistant material transparent to light having a wavelength of 180 nm or less.

The introduction can be timed based on a signal from a crankshaft angle detector and a data storage medium containing instructions for a processing system, such that when executed by said processing system said instructions cause the processing system and detector to control the timing of the ultraviolet light pulse.

In general, in another aspect, the invention features a diesel internal combustion engine that includes a UV radiation source arranged to provide pulsed UV radiation into one or more cylinders of the internal combustion engine to cause ignition of diesel fuel in the one or more cylinders when a crankshaft in a respective cylinder is at a preselected crankshaft angle.

Implementations of this aspect may include one or more of the following features and/or features of other aspects:

The UV radiation source can be an arc xenon flash lamp delivering at least 1 mJ (e.g., about 1 mJ, about 5 mJ, about 10 mJ, about 20 mJ, about 50 mJ) at wavelengths below 200 nm. The engine can further include a crankshaft angle detector, a data storage medium containing instructions, and a data processing system, where timing of the pulsed UV radiation is controlled by the data processing system based on information from the crankshaft angle detector. The pulsed UV radiation can be conveyed into each cylinder by a corresponding window or optical coupling made of high purity synthetic silica, sapphire, magnesium fluoride, lithium fluoride or another material transparent to light having a wavelength of 180 nm or less. The pulsed UV radiation can be arranged to provide atomic oxygen with the crankshaft angle between about 5° and 10° after top dead center (e.g., about 5°, about 6°, about 7°, about 8°, about 9°, about 10° after top dead center).

In general, in another aspect, the invention features a method that includes introducing atomic oxygen, ozone, plasma, and/or ions into one or more combustion chambers of a reciprocating internal combustion engine during a compression stroke prior to or during injection of fuel into the combustion chamber, where the atomic oxygen, ozone, plasma, and/or ions are introduced in an amount and at a time relative to the compression stroke to improve a timing of ignition and/or a localization of combustion of fuel in the combustion chamber.

Implementations of this aspect may include one or more of the following features and/or features of other aspects:

The atomic oxygen, ozone, plasma, and/or ions can be introduced by an electric arc corresponding to at least 1 joule of energy (e.g., about 1 J, about 2 J, about 3 J, about 4 J, about 5 J or more). The electric arc can be formed inside the combustion chamber. Energy for the electric arc can be stored in one or more capacitors and delivered to electrodes inside the combustion chamber. A voltage pulse can be delivered to an electrode inside the combustion chamber sufficient to trigger a discharge of the energy from the one or more capacitors. A timing of the introduction can be controlled based on a detected crankshaft angle of a piston in the combustion chamber.

In general, in another aspect, a reciprocating internal combustion engine includes an electric arc discharge device that includes electrodes positioned to provide electric discharge within a combustion chamber of a cylinder of the internal combustion engine, the electric discharge having sufficient energy to provide atomic oxygen, ozone, plasma, and/or ions within the combustion chamber. The engine also includes a crankshaft angle detector arranged to detect a crankshaft angle associate with the cylinder, and an electronic controller programmed to cause the electric arc discharge device to provide the electric discharge in the combustion chamber when the crank is at a preselected crankshaft angle.

Implementations of this aspect may include one or more of the following features and/or features of other aspects:

The electric discharge can have an energy of at least 1 joule (e.g., about 1 J, about 2 J, about 3 J, about 4 J, about 5 J or more). The electric discharge can be arranged to cause ignition of diesel fuel in the combustion chamber when the crankshaft angle is between about 5° to and 10° after top dead center (e.g., about 5°, about 6°, about 7°, about 8°, about 9°, about 10° after top dead center). The electric discharge can be arranged to cause combustion of most diesel fuel in the combustion chamber before a flame loses excessive heat by contact with the cylinder walls and a piston head in the cylinder.

Among other advantages, the systems and methods may provide substantial improvement in efficiency and/or performance of diesel engines or other internal combustion engines.

### BRIEF DESCRIPTION OF THE DRAWINGS

These and other features, aspects, and advantages of the present invention will become better understood with regard to the following description, appended claims and accompanying drawings, in which like reference numbers indicate like features, and wherein:

FIGS. 1A-D show a sequence of strokes of an example piston in a cylinder.

FIGS. 2A-B show example results from a model used to determined thermodynamic efficiency of an engine.

FIG. 3 shows an example UV light injector assembly.

FIG. 4 shows the top of one cylinder of an example combustion engine installed with the UV light injector assembly of FIG. 3.

FIG. 5 shows an example electric arc flash unit.

FIG. 6 shows the top of one cylinder of an example combustion engine installed with the electric arc flash unit of FIG. 5.

FIG. 7 shows an example electronic circuit used to create an electric arc.

### DETAILED DESCRIPTION

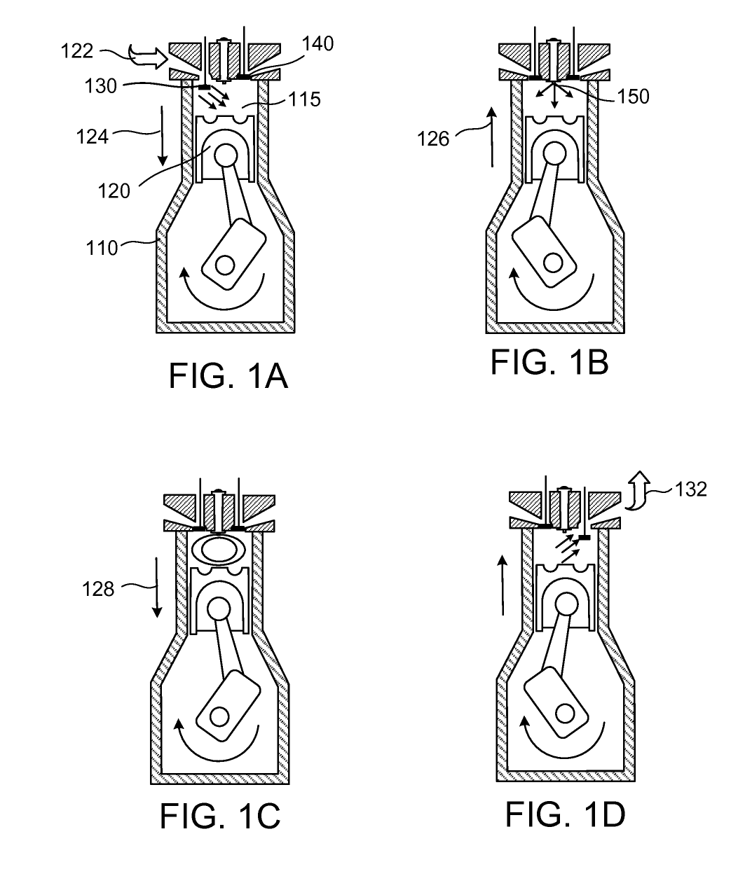

Both cooling system losses and exhaust losses in an ICE are determined by the in-cylinder pressure and temperature profile, which depends on the RPM, the time and duration of injection, the ignition delay, and the rate of burn. Referring again to FIGS. 1A-D, if ignition and combustion occur too early, the gas can lose too much heat to the cooling system during the compression stroke, before the power stroke even begins. If ignition and combustion occur too late, the hot gas can do work on the cylinder only during a late portion of the expansion stroke, wasting power when hot gas, still under pressure and possibly incompletely burned, is vented to the exhaust. Thus the proper onset and duration of combustion are critical to the efficient operation of a diesel engine.

To some extent the duration and speed of combustion can be controlled by the timing and rate of fuel injection and the spray nozzle configuration, but this approach is limited in scope because the combustion profile is also influenced by engine parameters such as stroke, bore, and RPM, and by fuel parameters such as cetane number, a measurement of intrinsic ignition delay.

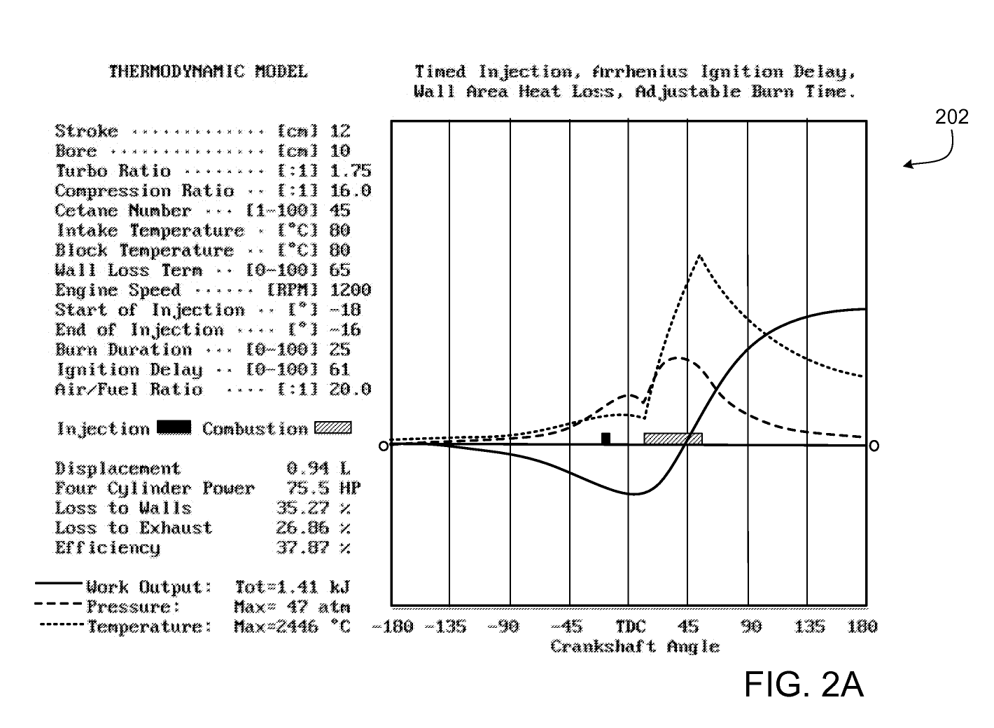

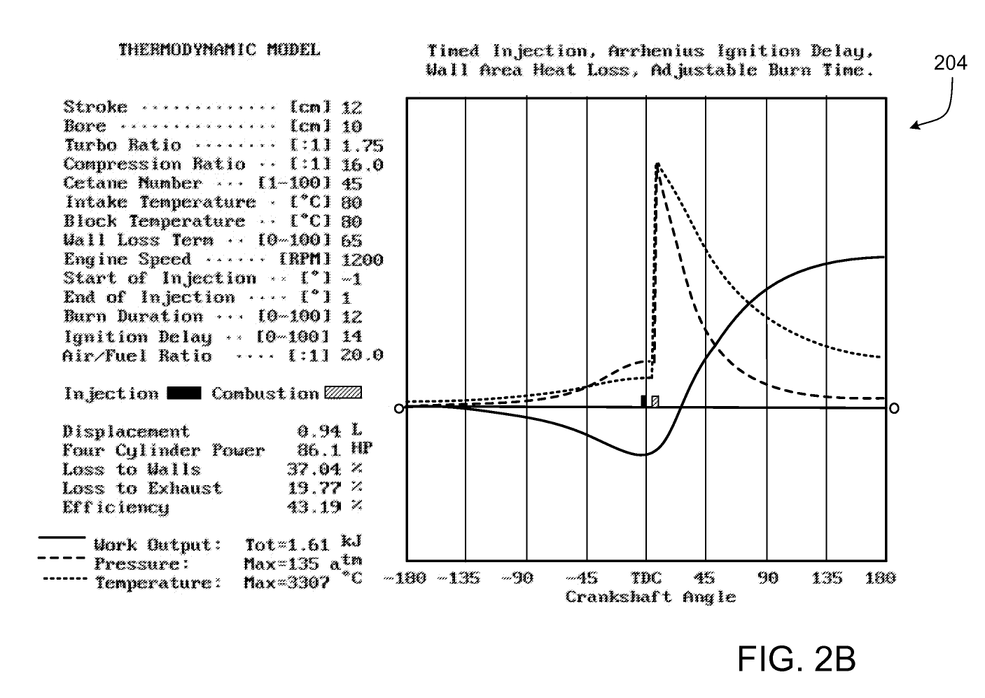

The interplay of these many factors can be modeled by simple stepwise computer programs which trace the history of temperature, pressure, heat loss and mechanical work as determined by the laws of ideal gas theory, thermodynamics, and heat flow. Calculations based on such models show that optimum efficiencies can achieved when rapid combustion is initiated shortly after TDC. FIGS. 2A-B are printouts of results 202 and 204 from one such model showing how the thermodynamic efficiency of a typical diesel engine can be increased from 37.9% to 43.2% when the onset of combustion is advanced from 10° to 5° after TDC, and completion of combustion is advanced from 55° to 10° after TDC. This improvement would be manifest as a 14.0% increase in power at the same fuel consumption. Here the phrase “thermodynamic efficiency” designates the frictionless work delivered by the engine, for example in kilojoules, divided by the thermal energy content of the consumed fuel expressed in the same units.

The results 202 and 204 in FIGS. 2A-B are based on a model of diesel performance patterned after the Carnot cycle. Each 0.1° iterative step is treated as an adiabatic process modified by a constant rate of heat input from the burning fuel. The rate of heat loss to the cooled cylinder walls is treated as proportional to (wall area)×(temperature difference), and an Arrhenius equation τ=AP⁻¹e^{B/T} is used to calculate the ignition delay ti at each temperature T and pressure P. The activation energy term B=618,840/(CN+25) is adjusted to reflect the ignition activation energy of the fuel, based on its cetane number (CN), and ignition is assumed to occur when ∫(dt/τ)=1. Heat released once the fuel ignites is distributed over a number of successive intervals determined by the duration of combustion as predicted by a similar Arrhenius equation (see, e.g., Equations (10.35), (10.38) and (10.36) in “Internal Combustion Engine Fundamentals,” John B. Heywood, McGraw-Hill, Inc. (1988)). Frictional losses have not been included in the above model; they would lead to a modest increase in the calculated percentage improvement.

Because models such as this reveal a considerable advantage in efficiency for combustion which begins and concludes shortly after TDC, that is the target at which methods for achieving better combustion should aim. To do that, some of the factors controlling the onset and rate of combustion should be modified. The presence one chemical species, atomic oxygen, in the immediate vicinity of the evaporating fuel is believed to be important to rapid combustion. It is further believed that the concentration of atomic oxygen can be greatly increased by photodissociation of oxygen molecules using a properly timed pulse of ultraviolet (UV) light of appropriate wavelength (i.e., having a sufficiently short wavelength).

An important factor controlling combustion is believed to be the nature of the oxidizing species encountered by the fuel. Normally the only such species is molecular oxygen, O₂, which for quantum mechanical reasons reacts relatively slowly with fuel molecules. Oxygen atoms would be capable of reacting more rapidly, but engine temperatures are not high enough to dissociate O₂ into significant amounts of free O. Thus auto-ignition of diesel fuel during compression must rely on a gradual increase in local temperature caused by relatively slow reactions involving molecular oxygen, such as

R—H+O═O->R^{•}+H—O—O^{•},

R—H+H—O—O^{•}->R^{•}+H—O—O—H,

H—O—O—H->2HO^{•},

R—H+HO^{•}->R^{•}+H₂O,

R^{•}+O═O->R—O—O^{•}, etc.

These reactions continue until they produce a temperature and free radical concentration high enough to initiate an avalanche of chain reactions. At that point ignition occurs and full combustion begins.

While normal combustion in diesel engines is controlled by engine operating conditions and the kinetics of slow reactions involving fuel and O₂ molecules, the situation would be far different if free O atoms were present, because such atoms react far more vigorously with fuel molecules to cause rapid ignition. Heat alone produces very few free O atoms, so diesel combustion can be improved by introducing free O atoms from some other source, when and where they will do the most good.

One way to provide oxygen atoms is by introducing ozone (O₃) as an oxygen atom precursor into the intake airstream. Ozone decomposes on heating to release free oxygen atoms

$${O}_{3} {—}^{heat} > {O}_{2} + O .$$

with a half-life of 0.1 to 0.5 msec at the temperatures of 400° C. to 600° C. and the pressures of 50 to 125 atmospheres occurring during diesel compression. That rate can be adequate of producing enough oxygen atoms to promote rapid ignition.

Although ozone is generally too unstable to be stored in bulk and then added to the intake airstream, it can be generated in the airstream by an electrical discharge. However, ozone generation in air drawn from the external environment is sensitive to ambient conditions such as temperature and humidity, and it is difficult to produce adequate concentrations of ozone using equipment having a useful service life. For both of these reasons in situ generation of ozone for use in diesels is presently considered unreliable.

In addition to such practical problems, there is another problem associated with the addition of an oxygen atom precursor such as ozone to the intake airstream, because the release of free oxygen atoms is dependent on the chemical properties of the additive and on the operating parameters of the engine, neither of which is susceptible to real-time control. Thus the release of oxygen atoms cannot readily be timed to optimize engine efficiency.

The applicants have discovered that these problems can be solved by producing free O atoms precisely when they will be most effective, by projecting an intense pulse of energetic UV light from a suitable source through a UV-transparent window into the combustion chamber. If this is done after the fuel has been injected and partially vaporized, but before it has spontaneously ignited, it leads almost immediately to a powerful burst of combustion whose timing and duration are under the direct control of the UV pulse.

The dissociation energy of an O₂ molecule corresponds to a photon wavelength of 242 nm. Radiation below that wavelength is strongly absorbed by O₂ with copious production of free O atoms. Ambient air, which is 21% oxygen, absorbs such UV so strongly that it cannot travel a significant distance in the presence of oxygen.

The absorption of UV light by O₂ increases rapidly at wavelengths below 242 nm. To produce a burst of O atoms throughout a significant volume inside the dense air near the top of a compression stroke, the UV should have a half-attenuation distance, λ_{1/2}=0.693/σn, of between 0.5 and 5.0 cm, where σ is the absorption cross-section per molecule in cm² and n is the number of molecules/cm³. At the top of a compression stroke, after a typical 1.5:1 turbocharge and 16:1 compression, for example, air contains about 6×10²⁰ molecules of oxygen/cc. Therefore one needs radiation with an absorption cross-section of roughly 10⁻²² cm², which corresponds to wavelengths just below 200 nm. For example, UV radiation having a wavelength of about 190 nm may be considered representative of effective oxygen-dissociating UV.

In short arc xenon discharge lamps a brief high current arc is struck between two closely spaced metal electrodes in a xenon atmosphere. This results in a powerful burst of visible and ultraviolet radiation comprised of characteristic xenon emission lines superimposed on a background of black-body radiation. Such a lamp, for example, the Excelitas model 4402 (commercially available from Excelitas Technologies Corp., Waltham, Mass.), can be operated at a power level as high as 60 watts while flashing 60 times a second and delivering up to 100 mJ of total optical energy per flash. Since about 2% of the total optical output of a short arc xenon lamp lies in the range of interest below 200 nm, at maximum power the output of useful UV can be as high as 2 mJ.

Spontaneous ignition of hydrocarbon vapor has been found to be induced by oxygen atoms at concentrations of 10¹⁵ O atoms/cc or higher. To be useful for ignition control a UV flash lamp thus needs to produce that concentration throughout an in-cylinder illuminated volume of about 2 cc. Successful ignition therefore requires using 10¹⁵ UV photons of appropriate wavelength to dissociate at least 10¹⁵ O₂ molecules into 2×10¹⁵ O atoms.

A 190 nm photon carries about 10⁻¹⁵ mJ of energy, so 10¹⁵ photons represent about 1.0 mJ. That is well within the 2 mJ/flash capability of a single flash from a short arc xenon flash lamp. In an engine operating at 3600 RPM there are 30 compression strokes per second in each cylinder, so if necessary two flashes may be used in rapid succession to deliver as much as 4 mJ to the fuel-air mixture.

To make effective use of the optical output of a xenon flash lamp, suitable optics, fabricated from a material highly transparent at 190 nm, and thermally and mechanically strong enough to survive exposure to the in-cylinder combustion region, should be used. Commercially available synthetic fused silica and sapphire are examples of such materials. Of these, silica is more thermally and chemically durable. Other examples of materials that may be used are crystalline quartz and CaF₂. UV-transparent windows will not become occluded by the accumulation of combustion products, because the UV energy deposited in any optically absorbing deposit on the surface of the window will lead to rapid vaporization or displacement.

Embodiments disclosed herein improve (e.g., optimize) the efficacy of oxygen atom production by automatically producing O atoms precisely when and where they are needed, namely in the sheath of combustible fuel vapor which envelopes the evaporating fuel droplets. This is accomplished by introducing an intense flash of light, containing short wavelength UV radiation, directly into the top of the engine cylinder near the desired time of ignition.

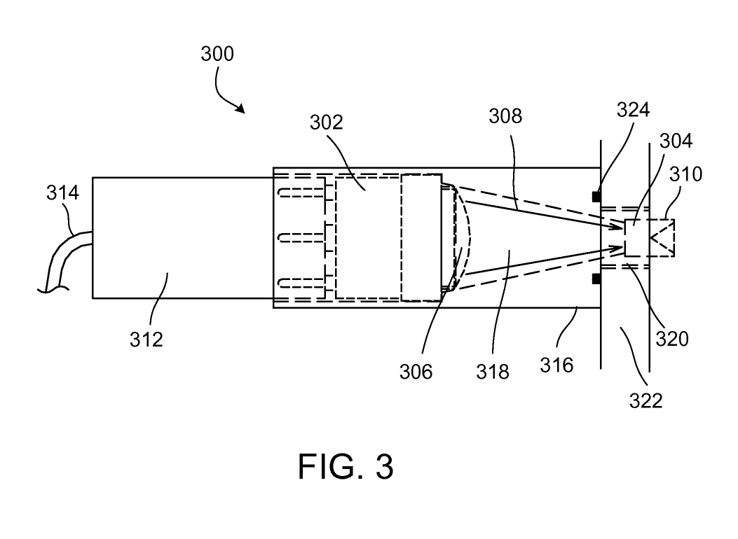

FIG. 3 shows an exemplary embodiment of a UV light injector assembly 300 for applying intense light that includes short wavelength UV to the interior of an engine cylinder near the desired time of fuel ignition. In this embodiment, the light is produced by a short-arc xenon flash lamp 302, though other light sources can be used. This flash lamp 302 includes an integral reflector (e.g., a parabolic reflector) to collimate the majority of its light into parallel rays. Assembly 300 includes a window 304 for passing UV light into the cylinder. For practical considerations in the construction of many internal combustion engines, the window should be relatively small, for example 2 to 10 mm in diameter, and preferably 4 to 8 mm in diameter. To direct the collimated rays of light from the flash lamp 302 through the window 304 a UV-transparent condensing lens 306 is used to focus the light 308 from the flash lamp 302 onto the window 304. For transparency of short wavelength UV, the condensing lens 306, window 304, and window extension 310 can be made of synthetic fused silica, sapphire, or other strong, heat-resistant, UV transparent material. Likewise, the flash lamp 302 envelope uses one of these UV transparent materials to allow the UV light to exit. An alternative construction is to use a flash lamp 302 with a reflector (e.g., an ellipsoidal reflector) that provides focused light output, rather than collimated rays. This configuration eliminates the need for the condensing lens 306.

FIG. 3 also shows an alternate window shape 310 that includes a protrusion into the engine cylinder. This protrusion has a concave depression in the end, such as a conical indentation, to use a reflective surface or total internal reflection to distribute the light inside the cylinder for more effective illumination of the combustion volume. The window extension 310 may be asymmetrical, particularly if the window 304 is not centered in the top of the cylinder head. The shape of the extension can be used to direct the light to the desired position in the engine cylinder.

In addition to the optical components, this configuration includes an electrical connector and trigger module 312 for the flash lamp 302. This module has one or more wires 314 that connect to a power source and a flash timing controller (not shown) that assures that the flash of light occurs with the desired intensity and at the desired time.

A mechanical housing 316 holds all the optical and electrical components in the proper position and contains a UV-transparent atmosphere 318 such as a near vacuum, nitrogen gas, or another gas that does not significantly absorb the short wavelength UV. The mechanical housing 316 includes a threaded protrusion 320 that holds the window 304 and screws into the engine cylinder head 322 to direct the light 308 into the cylinder. A pressure seal 324 is included around the threaded protrusion 320 to contain the high pressure gasses in the engine cylinder. The mechanical housing 316 is preferably hexagonal in cross-section for easy screwing and tightening into the cylinder head 322. This mechanical configuration can be easily attached or detached from the engine (with the same ease as a spark plug) for repair or replacement.

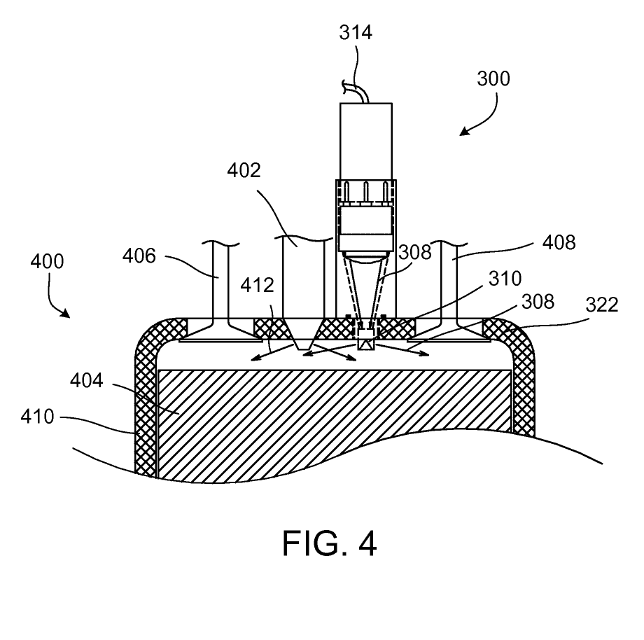

FIG. 4 shows a simplified diagram of the top of one cylinder 400 of an internal combustion engine with the UV light injector assembly 300 installed so that the light distributor extension 310 of the window protrudes through the engine cylinder head 322 into the combustion space at the top of the engine cylinder. The UV light injector assembly 300 is positioned near the fuel injector 402 so the UV light 308 can illuminate the volume into which the fuel is injected. The light distributor 310 can be shaped such that the light from the flash lamp is primarily directed to the desired volume where the combustion will be initialized.

One or more wires 314 connect the UV light injector assembly 300 to a power source and flash timing controller (not shown) that cause the flash of light to occur at the desired time. This time will typically be when the piston 404 is near the top of the compression stroke, for example between a crankshaft angle of 10° before TDC to 10° after TDC, which is equivalent to 1.4 msec before to 1.4 msec after TDC at 1200 RPM. At this time both the intake valve 406 and the exhaust valve 408 are closed so the hot air contained within the volume created by the cylinder walls 410, piston 404, and cylinder head 322 is compressed and ready to support combustion. The fuel injector 402 injects a fuel spray 412 into the combustion volume when the air is compressed to near the minimum volume. The controller for the UV light injector assembly 300 triggers the flash of light at approximately the time the fuel is injected (typically just before or as the fuel is injected). The UV light can dissociate oxygen in the air to produce atomic oxygen to promote rapid initialization of combustion. The energy from the flash of light can also contribute to the evaporation of the fuel droplets for more rapid burning.

The timing of the light flash from the UV light injector assembly 300 is determined by sensing the rotational angle of the crankshaft. The angle of the crankshaft also determines the position of the piston in the cylinder. Reciprocating engines already include a mechanism to control the intake and exhaust valve timing and the fuel injector timing; all of which must occur at specific positions of the piston in the cylinder. This timing is typically determined with a direct mechanical linkage to the crankshaft, such as with a cam shaft directly coupled to the crankshaft rotation, or with a crankshaft angular position sensor. Angular position sensors typically consist of a magnetic sensor positioned next to a gear coupled to the crankshaft rotation. The teeth on the gear are detected by the magnetic sensor to determine the rotational position. One or more of the teeth on the gear are modified or missing to provide an absolute rotational position reference. This technology is common in reciprocating engines and is well known to those skilled in the art. The crankshaft rotational position sensor can also provide crankshaft angle and piston position information to the UV light injector controller in order to determine the precise timing for the flash of light.

Another method of creating an intense flash of light containing short wave UV radiation is to use an electric arc in an air atmosphere rather than using an inert gas such as xenon as described above. In air, the two electrodes that create the electrical arc may not need a transparent envelope around. Accordingly, such embodiments may avoid aging issues that can occur when using electrodes having transparent electrodes, such as reduced transparency of the envelope material that can occur with use. The arc electrodes can be positioned inside each engine cylinder so all the light emitted from the arc is inside the cylinder volume. This can reduce (e.g., eliminate) the cost and energy losses that result from optics necessary to direct the light from an external flash lamp into the cylinder.

A high current electrical arc in air is known to produce a significant amount of UV light. For example, workers using arc welding equipment wear protective clothing to prevent skin or eye damage from the intense UV light created by the welding arc through air. In fact, at high current density, it is believed that air is nearly as efficient at generating UV light as a xenon arc lamp. Because of the xenon line spectrum, xenon arc lamps produce some UV light efficiently when operated with low current density, but when operated at high current density, the UV light output is primarily the result of the very high temperature gas acting as a black body radiator. An electrical arc in air may also create a very high temperature gas that acts as a black body radiator to produce a significant amount of UV light output, so a high current density air arc lamp may work nearly as well as a xenon lamp in this mode.

In this configuration, the electric arc is positioned inside the engine cylinder and driven to produce a flash of intense UV light before or at the time of the fuel injection into the cylinder. This results in the production of monatomic oxygen atoms precisely when and where they are needed, namely in the sheath of combustible fuel vapor which envelopes the evaporating fuel droplets. The production of monatomic oxygen is further enhanced beyond that produced by the UV light by the electric field and current passing through the air, and also by the high temperature and ionization of the air in the electric arc.

The presence of atomic oxygen, ozone, plasma, and/or ions in the combustion chamber at or near the time of fuel injection can (a) promote ignition at the most efficacious time, namely a few degrees of crankshaft angle after top dead center, and (b) promote combustion in the most efficacious location, namely near the injector and away from cool metal walls capable of causing excessive heat loss.

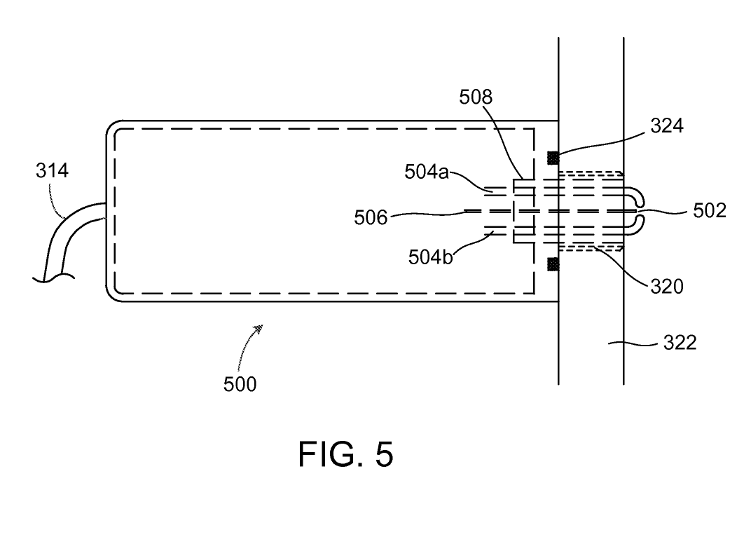

FIG. 5 shows an example configuration of an electric arc flash unit 500 for creating an intense flash of light, containing short wave UV radiation, directly inside an engine cylinder. In this example configuration, an electric arc 502 is created between two arc electrodes 504a-b which extend through the cylinder head 322 into the internal volume of the engine cylinder. The arc electrodes are connected to a source of electrical energy of sufficient voltage (typically 1,000V to 3,000V) to create a high energy electric arc between the arc electrodes 504a-b. Because of the high air pressure in the cylinder, a third higher voltage trigger electrode 506 is used to initiate the arc and control the precise timing.

The energy for the electric arc 502 is stored in one or more capacitors that are contained in the housing of the electric arc flash unit 500, or alternatively in a remote location if dictated by available space or the need for lower operating temperature. Control wires 314 connect to the control electronics (not shown) to provide the energy to charge the capacitors, and to provide the trigger signal to initiate the electrical arc 502 at the desired time. If the energy storage capacitors are in a remote location, these wires include the two conductors that connect directly to the arc electrodes 504a-b. In general, the control electronics can include standard and/or custom components, such as data storage media (e.g., a non-volatile memory chip) and an electronic processor (e.g., an ASIC).

The electric arc flash unit 500 includes a threaded protrusion 320 that is screwed into a hole in the cylinder head 322. The central portion of this protrusion is filled with a high temperature insulating material 508, such as ceramic, to keep the electrodes 504a-b and 506 electrically isolated from each other and to provide a seal to contain the high pressure gasses in the cylinder. A pressure seal 324 is also included around the threaded protrusion 320 to contain the high pressure gases in the cylinder.

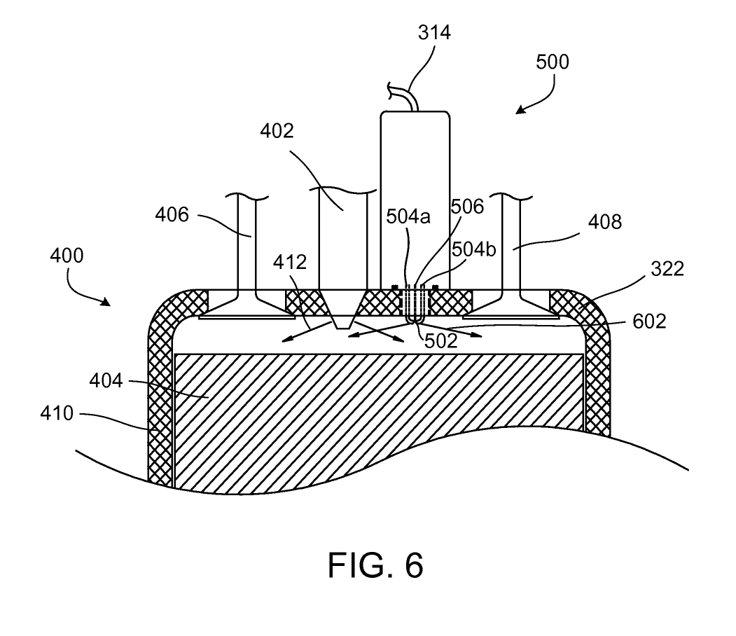

FIG. 6 shows a simplified diagram of the top of one cylinder 400 of an internal combustion engine with the electric arc flash unit 500 installed so that the threaded protrusion 320 extends through the engine cylinder head 322 into the combustion space at the top of the engine cylinder 410. The electric arc flash unit 500 is positioned near the fuel injector 402 so the UV light 602 from the electric arc 502 can illuminate the volume into which the fuel is injected.

One or more wires 314 connect the electric arc flash unit 500 to a power source and flash timing controller (not shown) that cause the flash of light with short wave UV radiation to occur at the desired time. This time will typically be in the span of time after the cylinder has been filled with the intake air, and before or during the fuel injection. This corresponds to the interval when the piston 404 is moving upward in its compression stroke. During this time both the intake valve 406 and the exhaust valve 408 are closed so the air contained within the volume created by the cylinder walls 410, piston 404, and cylinder head 322 is being compressed and heated to support combustion. The fuel injector 402 then injects one or more jets or sprays of fuel 412 into the combustion volume when the air is compressed to near the minimum volume. The UV light and electrical energy from the electric arc flash unit 500 can dissociate oxygen in the air inside the cylinder to produce atomic oxygen and its daughter products, such as ozone, to promote rapid ignition and localized combustion.

The timing of the light flash from the electric arc flash unit 500 is determined by sensing the rotational angle of the crankshaft. The angle of the crankshaft also determines the position of the piston in the cylinder. Reciprocating engines conventionally include a mechanism to control the intake and exhaust valve timing and the fuel injector timing; all of which should occur at specific positions of the piston in the cylinder. This timing is typically determined with a direct mechanical linkage to the crankshaft, such as with a cam shaft directly coupled to the crankshaft rotation, or with a crankshaft angular position sensor. Angular position sensors typically consist of a magnetic sensor positioned next to a gear coupled to the crankshaft rotation. The teeth on the gear are detected by the magnetic sensor to determine the rotational position. One or more of the teeth on the gear are modified or missing to provide an absolute rotational position reference. This technology is common in reciprocating engines and is well known to those skilled in the art. The crankshaft rotational position sensor can also provide crankshaft angle and piston position information to the electric arc flash unit controller which determines the precise timing for the flash of light.

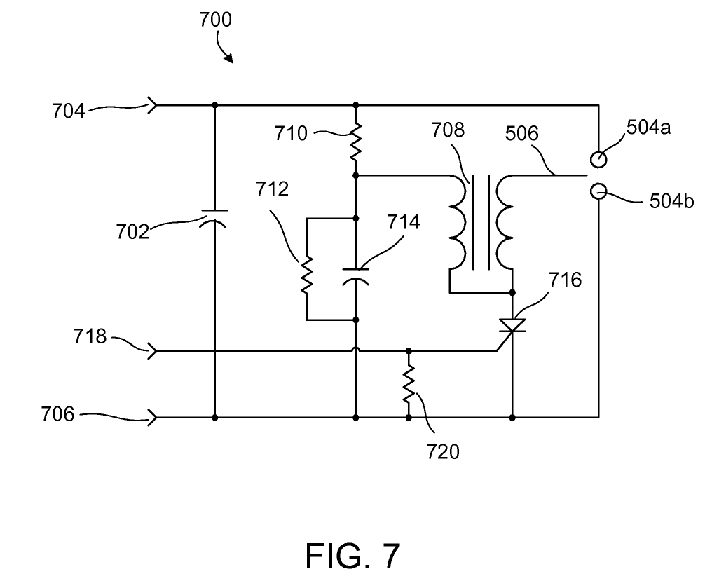

FIG. 7 shows a schematic diagram of an electronic circuit 700 that can be used to create the electric arc 502 to generate an intense flash of light containing short wave UV radiation. The components of this circuit can be positioned inside the mechanical housing of the electric arc flash unit 500 that attaches to the cylinder head, or alternatively, some or all of the components can be positioned in a remote location with wires that connect to the electrodes 504a-b and 506.

The circuit 700 includes of one or more energy storage capacitors 702 that hold energy for rapid electrical current delivery to the arc electrodes 504a-b to create the flash of light. For highest efficiency of UV light production, the energy storage capacitors 702 should be charged to a voltage greater than 1,000V. Higher voltages provide higher peak current and greater UV light production, but generally require more expensive components and better electrical insulation. If other system constraints demand a lower voltage, useful results can be achieved with voltages as low as a few hundred volts. The energy storage capacitors 702 are charged from an external high voltage power supply (not shown) which applies the charging current 704 to the energy storage capacitors 702 with a ground return connection 706. The energy storage capacitors 702 are charged during the interval of time between the flashes created by the electrical arc 502.

The value of the energy storage capacitors 702 is chosen to provide the desired amount of energy to the flash. Flash energy will typically be in the range of 1 to 10 joules per flash depending on the size of the engine and other operating characteristics. The energy in the energy storage capacitors 702, in joules, may be expressed by the formula 1/2 CV² where C is the total capacitor value in Farads, and V is the voltage on the capacitor(s). For example, a 2 microfarad capacitor charged to 2 KV would store 4 joules of electrical energy.

Because of the high air pressure in the cylinder, a higher voltage trigger electrode 506 may be needed to partially ionize the air between the arc electrodes 504a-b to initiate the electric arc 502. The voltage needed for the trigger electrode 506 is determined by cylinder gas pressure at the time of the arc. The cylinder pressure is determined by the compression ratio of the engine and the timing of the flash during the compression stroke of the cylinder. The required trigger voltage is typically in the range of 5,000 volts to 50,000 volts. The trigger voltage can be a very short pulse with a width on the order of 1 microsecond (e.g., having a FWHM in a range from 0.5 microseconds to 5 microseconds). These pulses can be produced using a trigger transformer 708 designed for use with standard xenon flash lamps. Standard flash trigger transformers 708 are typically designed to be powered from a voltage of approximately 200V to 300V, so this circuit includes a voltage divider made up of resistors 710 and 712 to provide the appropriate voltage from the higher voltage energy storage capacitors 702. An additional, much smaller, trigger energy storage capacitor 714 holds energy for the trigger transformer 708 to produce the high voltage trigger pulse. The trigger pulse is produced when the flash trigger SCR 716 is turned on with a flash trigger signal 718 from the control electronics (not shown). When the flash trigger SCR 716 is turned on, current flows from the trigger energy storage capacitor 714 through the flash trigger transformer 708 to electrical ground 706. The windings in the flash trigger transformer 708 have a high ratio (e.g., 20 to 100 as needed) between the secondary and primary to produce the high voltage trigger pulse to the trigger electrode 506. Resistor 720 is included to reduce the likelihood of triggers to the flash trigger SCR 716 due to spurious electrical noise on the flash trigger signal line 718. In an example implementation, resistors 710, 712, and 720 are 1M ohm, 100K ohm, and 1K ohm resistors, respectively, trigger energy storage capacitor 714 is a 0.47 μF capacitor, trigger electrode 506 delivers a 25 KV pulse, and the voltage differential between arc electrodes 504a-b is 1 to 3 KV.

The components, steps, features, objects, benefits and advantages that have been disclosed above are merely illustrative. None of them, or the discussions relating to them, is intended to limit the scope of protection in any way. Numerous other embodiments are also contemplated, including embodiments that have fewer, additional, and/or different components, steps, features, objects, benefits and advantages.

Nothing that has been stated or illustrated is intended to cause a dedication of any component, step, feature, object, benefit, advantage, or equivalent to the public. While particular embodiments of the present application have been described, variations of the present application can be devised without departing from the inventive concepts disclosed in the disclosure.

### EXAMPLES

### Example 1

To determine the yield of atomic oxygen produced by an Excelitas model 4402 xenon flash lamp, a flash lamp and power assembly similar to that shown in FIG. 3 is fitted to a test chamber made of an aluminum tube 6″ long having an ID of 2.75″ and a wall thickness of 0.75″, equipped with aluminum end plates 0.75″ thick secured in place by four external threaded rods, and sealed to the ends of the tube by silicone O-rings. The lamp assembly is mounted on the center of one end plate so as to shine along the axis. The opposite end plate is fitted with a needle valve inlet for compressed air, a pressure gauge, a high pressure relief valve, and a port for mounting an observation window, a sample collector, and/or an ozone detector. The assembled device is capable of sustaining pressures as high as 100 atmospheres and temperatures as high as 100° C.

In this inert environment any atomic oxygen formed will react rapidly with molecular oxygen to yield ozone, O+O₂->O₃. Measurement of the ozone concentration therefore provides an indirect but accurate indication of the initial atomic oxygen concentration. The results of tests performed using this assembly are summarized in the following table, with the number of oxygen atoms calculated from the ozone concentration and the chamber volume of 420 ml.

TABLE 1

| | | | | Total Number |
|---|---|---|---|---|
| Pressure in | Number of | Input Energy | Ozone | of Oxygen |
| Chamber (bar) | Flashes | per Flash (J) | Conc. (ppb) | Atoms |
| 1 | 10 | 0.25 | 100 | 1 × 10¹⁵ |
| 1 | 10 | 0.25 | 1000 | 1 × 10¹⁶ |
| 1 | 1 | 1.0 | 400 | 4 × 10¹⁵ |
| 1 | 10 | 1.0 | 4000 | 4 × 10¹⁶ |
| 10 | 1 | 0.25 | 10 | 1 × 10¹⁵ |
| 10 | 10 | 0.25 | 100 | 1 × 10¹⁶ |
| 10 | 1 | 1.0 | 40 | 4 × 10¹⁵ |
| 10 | 10 | 1.0 | 400 | 4 × 10¹⁶ |
| 100 | 1 | 0.25 | 1 | 1 × 10¹⁵ |
| 100 | 10 | 0.25 | 10 | 1 × 10¹⁶ |
| 100 | 1 | 1.0 | 4 | 4 × 10¹⁵ |
| 100 | 10 | 1.0 | 40 | 4 × 10¹⁶ |

It can be seen that the yield of oxygen atoms is consistently equal to about 4×10¹⁵ atoms per joule of total energy. This shows that the UV radiation from a xenon lamp driven at 0.5 J/flash is capable of producing 10¹⁵ atoms of oxygen per cc throughout a 2 cc illuminated volume, a concentration sufficient to cause spontaneous ignition of hydrocarbon vapor.

### Example 2

A flash lamp and power assembly similar to that shown in FIG. 3 and employed in example 1 is mounted on each of the four cylinders of a John Deere M4024T diesel engine, and is provided with a timing circuit keyed to the crankshaft angle. The engine is operated at a governed speed of 1800 RPM while driving a 60 hertz AC generator connected to a variable load. When tests are conducted using the UV flash lamp to control ignition the timing circuit is adjusted to produce a flash about 5° after top dead center.

The engine is allowed to equilibrate under each set of test conditions for 5 minutes and is then operated for an accurately timed 15 minute test period. Fuel consumption is obtained by weighing the fuel container before and after the test period.

Table 2 shows the total fuel consumed under different test conditions.

TABLE 2

| UV Ignition | Load (kW) | Fuel Consumed (gm) |
|---|---|---|
| Off | 5 | 450 |
| On | 5 | 360 |
| Off | 10 | 900 |
| On | 10 | 720 |
| Off | 15 | 1350 |
| On | 15 | 1080 |
| Off | 20 | 1800 |
| On | 20 | 1440 |

It can be seen that over this range of loads a consistent 20% reduction in fuel consumption is provided by pulsed UV control.

A number of embodiments are described. Other embodiments are in the following claims.

What is claimed is:

1. A method, comprising:
introducing atomic oxygen and diesel fuel into a combustion chamber in a cylinder of a diesel engine, wherein the introduction is timed relative to a compression cycle of the cylinder to cause the diesel fuel to ignite with a crankshaft angle near a top of a compression stroke of a piston in the combustion chamber.

2. The method of claim 1, wherein the ignition of the diesel fuel occurs with the crankshaft angle between about 5° and 10° after top dead center.

3. The method of claim 1, wherein the atomic oxygen is introduced by a pulse of ultraviolet light having at least 1 mJ joule of energy at wavelengths below 200 nm.

4. The method of claim 3, wherein the pulse of ultraviolet light is produced by a short arc xenon flash lamp and is introduced into the combustion zone through a window or optical coupling.

5. The method of claim 4, wherein the window or optical coupling is made of high purity synthetic fused silica, sapphire, or another strong, heat-resistant material transparent to light having a wavelength of 180 nm or less.

6. The method of claim 3, wherein the introduction is timed based on a signal from a crankshaft angle detector and a data storage medium containing instructions for a processing system, such that when executed by said processing system said instructions cause the processing system and detector to control the timing of the ultraviolet light pulse.

7. A diesel internal combustion engine, comprising:
a UV radiation source arranged to provide pulsed UV radiation into one or more cylinders of the internal combustion engine to cause ignition of diesel fuel in the one or more cylinders when a crankshaft in a respective cylinder is at a preselected crankshaft angle.

8. The system of claim 7, wherein the UV radiation source is an arc xenon flash lamp delivering at least 1 mJ at wavelengths below 200 nm.

9. The system of claim 7, further comprising a crankshaft angle detector, a data storage medium containing instructions, and a data processing system, wherein timing of the pulsed UV radiation is controlled by the data processing system based on information from the crankshaft angle detector.

10. The system of claim 7, wherein the pulsed UV radiation is conveyed into each cylinder by a corresponding window or optical coupling made of high purity synthetic silica, sapphire, magnesium fluoride, lithium fluoride or another material transparent to light having a wavelength of 180 nm or less.

11. The system of claim 7, wherein the pulsed UV radiation is arranged to provide atomic oxygen with the crankshaft angle between about 5° and 10° after top dead center.

12. A method, comprising:
introducing atomic oxygen, ozone, plasma, and/or ions into one or more combustion chambers of a reciprocating internal combustion engine during a compression stroke prior to or during injection of fuel into the combustion chamber,
wherein the atomic oxygen, ozone, plasma, and/or ions are introduced in an amount and at a time relative to the compression stroke to improve a timing of ignition and/or a localization of combustion of fuel in the combustion chamber.

13. The method of claim 12, wherein the atomic oxygen, ozone, plasma, and/or ions are introduced by an electric arc corresponding to at least 1 joule of energy.

14. The method of claim 13 wherein the electric arc is formed inside the combustion chamber.

15. The method of claim 13, wherein energy for the electric arc is stored in one or more capacitors and delivered to electrodes inside the combustion chamber.

16. The method of claim 15 wherein a voltage pulse is delivered to an electrode inside the combustion chamber sufficient to trigger a discharge of the energy from the one or more capacitors.

17. The method of claim 13, wherein a timing of the introduction is controlled based on a detected crankshaft angle of a piston in the combustion chamber.

18. A reciprocating internal combustion engine comprising:
an electric arc discharge device comprising electrodes positioned to provide electric discharge within a combustion chamber of a cylinder of the internal combustion engine, the electric discharge having sufficient energy to provide atomic oxygen, ozone, plasma, and/or ions within the combustion chamber; and
a crankshaft angle detector arranged to detect a crankshaft angle associate with the cylinder; and
an electronic controller programmed to cause the electric arc discharge device to provide the electric discharge in the combustion chamber when the crank is at a preselected crankshaft angle.

19. The system of claim 18, wherein the electric discharge has an energy of at least 1 joule.

20. The system of claim 18, wherein the electric discharge is arranged to cause ignition of diesel fuel in the combustion chamber when the crankshaft angle is between about 5° to and 10° after top dead center.

21. The system of claim 18, wherein the electric discharge is arranged to cause combustion of most diesel fuel in the combustion chamber before a flame loses excessive heat by contact with the cylinder walls and a piston head in the cylinder.
